(19) United States
(12) Patent Application Publication
(10) Pub. No.: US 2006/0130976 A1
(43) Pub. Date: Jun. 22, 2006

(54) Thermal activation apparatus and printer including the same

(76) Inventors: Masanori Takahashi, Chiba-shi (JP); Minoru Hoshino, Chiba-shi (JP); Hiroyuki Kohira, Chiba-shi (JP); Tatsuya Obuchi, Chiba-shi (JP); Yoshinori Sato, Chiba-shi (JP)

Correspondence Address: BRUCE L. ADAMS, ESQ., SUITE 1231, 17 BATTERY PLACE, NEW YORK, NY, 10004, US

(21) Appl. No.: 11/288,741

(22) Filed: Nov. 29, 2005

(30) Foreign Application Priority Data
Dec. 9, 2004 (JP) 2004-356347

(51) Int. Cl. B32B 37/00

(52) U.S. Cl. 156/384; 156/538

(57) ABSTRACT

Provided is a thermal activation apparatus in which a discharge path of a heat-sensitive adhesive label is not adversely affected by adhesive residue. The thermal activation apparatus comprises a discharge mechanism (15) for completely discharging a heat-sensitive adhesive label with its heat-sensitive adhesive agent layer formed on the back side heated by a thermal head from between the thermal head and a platen roller. The discharge mechanism (15) is structured such that two shafts (15b and 15c) made of metal are passed through a plurality of belts (15a) which are endless elastic members, the two shafts (15b and 15c) are disposed at given intervals from each other and in parallel with each other, and the two shafts (15b and 15c) are rotatably supported. By rotating one of the two shafts (15b and 15c) as a driving shaft, the belts (15a) rotate to be able to discharge the heat-sensitive adhesive label (1) fed thereonto.

### BACKGROUND OF THE INVENTION

1. Field of the Invention

The present invention relates to a thermal activation apparatus for transporting a sheet material having a thermally activated adhesive surface formed on one side thereof, which becomes adhesive when heated, and for heating the thermally activated adhesive surface of the sheet material, and to a printer including the same.

2. Description of the Related Art

These days, an adhesive label for a bar code, a price tag, or the like which often has an adhesive agent layer formed on the back side of a recording surface (printing surface), is stored with backing paper or a release liner stuck thereon to temporarily adhere the adhesive to the backing paper or the release liner. However, this type of an adhesive label is inconvenient because it is necessary to peel off the release liner from the adhesive agent layer when the label is used and waste is inevitably generated.

For this reason, as a system where no release liner is required, a heat-sensitive adhesive label having a heat-sensitive adhesive agent layer formed on the back side of a sheet-like substrate which, under normal conditions, does not exhibit adhesion, but when heated, generates adhesion, and a thermal activation apparatus for heating the heat-sensitive adhesive agent layer formed on the back side of the label to generate its adhesion have been-developed.

For example, as the above-mentioned thermal activation apparatus, an apparatus using as heating means various kinds of heating system such as a heat roll system, a hot air spray system, an infrared radiation system, and a system using an electric heater or a dielectric coil have been proposed. Further, JP 11-79152 A discloses technology where a thermal activation head having as heat sources a plurality of resistors (heating elements) provided on a ceramic substrate comes in contact with a heat-sensitive adhesive label to heat the heat-sensitive adhesive agent layer, for example, a thermal head used as a print head of a thermal printer.

The structure of such a thermal activation apparatus will be described using an example of a system having a thermal activation head which is disclosed in JP 11-79152 A. FIG. 4 is a schematic sectional view illustrating an exemplary structure of a conventional thermal activation apparatus.

A heat-sensitive adhesive label 1 used in the thermal activation apparatus illustrated in FIG. 4 has a structure where, for example, a printable layer is formed on a front side of a sheet-like substrate while a heat-sensitive adhesive agent layer formed by applying and drying a heat-sensitive adhesive is formed on a back side of the sheet-like substrate.

The thermal activation apparatus includes a thermal head 2 having heating elements for heating the heat-sensitive adhesive agent layer formed on the back side of the heat-sensitive adhesive label 1, a platen roller 3 for transporting the heat-sensitive adhesive label 1 with the heating elements of the thermal head 2 in contact with the heat-sensitive adhesive label 1, insert rollers 4 for inserting the heat-sensitive adhesive label 1 between the thermal head 2 and the platen roller 3, and a discharge roller 5 for completely discharging the heat-sensitive adhesive label 1 with its heat-sensitive adhesive agent layer formed on the back side heated by the thermal head 2 from between the thermal head 2 and the platen roller 3. Further, a catching portion 6 for catching a trailing edge of the heat-sensitive adhesive label 1 which droops under its own weight is provided over the discharge roller 5 to prevent the heat-sensitive adhesive label 1 with the adhesion of its heat-sensitive adhesive agent layer formed on the back side generated from dropping from the thermal activation apparatus and sticking to a desk or the like when it is completely discharged from between the thermal head 2and the platen roller 3 is provided.

The reason that the above-described thermal activation apparatus is provided with the discharge roller 5 is that, if the trailing edge of the heat-sensitive adhesive label 1 remains between the thermal head 2 and the platen roller 3 when heating of the heat-sensitive adhesive agent layer of the heat-sensitive adhesive label 1 is completed, the heat-sensitive adhesive label 1 may stick to the thermal head 2, or, when the surface of the heat-sensitive adhesive label 1 is a heat-sensitive printing layer, the printing surface may be colored by residual heat, and thus, it is necessary for the heat-sensitive adhesive label 1 to be completely discharged by the discharge roller 5 from between the thermal head 2 and the platen roller 3.

Since the discharge roller 5 is a component which comes in contact with the adhesive surface of the heat-sensitive adhesive label 1, for the purpose of making the adhesive surface to be smoothly separated from the discharge roller 5 without sticking to the discharge roller 5 when the label is discharged, nonadhesive material such as a fluoroplastic is used as the material of the roller, or, the contact area of the discharge roller 5 with the heat-sensitive adhesive label 1 is made smaller.

As a conventional discharge roller in which these measures are taken, for example, one illustrated in FIG. 5 is used where a plurality of O rings 5b made of a fluoroplastic are arranged on a shaft 5a.

### SUMMARY OF THE INVENTION

However, even in the conventional case of the discharge roller where a material such as fluoroplastic to which an adhesive is difficult to stick is used as the O ring, once adhesive residue adheres to the perimeter of the O ring, and since additional residue accumulates on the attached residue, the discharge path of the heat-sensitive adhesive label may be clogged in the course of time, which adversely affects discharge of the heat-sensitive adhesive label.

The present invention is made in view of the above-described problem of the prior art. An object of the present invention is to provide a thermal activation apparatus where the discharge path of a heat-sensitive adhesive label is not adversely affected by adhesive residue and to provide a printer including the same.

In order to achieve the above object, the present invention provides a thermal activation apparatus including: a heating head for heating a heat-sensitive adhesive agent layer formed on one side of a heat-sensitive adhesive label; and a discharge mechanism for discharging the heat-sensitive adhesive label in contact with the heat-sensitive adhesive agent layer exhibiting adhesion after being heated by the heating head, in which the, discharge mechanism includes: an endless elastic belt; a pair of rotatably supported shafts disposed at given intervals from each other in a loop made by the endless elastic belt such that the internal diameter of the endless elastic belt is increased; and drive means for rotationally driving one of the shafts.

According to a first aspect of the present invention, by disposing a pair of shafts at given intervals from each other in a loop made by an endless elastic belt such that the internal diameter of the elastic belt is increased, the elastic belt is held under tension. When the belt is moved by driving one of the shafts to rotate by drive means with this state maintained, tension difference of the belt is caused between a place where the belt is in contact with the shafts and a place where the belt is not in contact with the shafts, and between a place where the belt is in contact with the driving shaft and a place where the belt is in contact with the driven shaft, and thus, the belt is expanded and contracted in places. In other words, this has the effect of squeezing the belt in places. Therefore, even when residue of adhesive on the back side of a heat-sensitive adhesive label sticks to the surface of the belt during the heat-sensitive adhesive label is discharged, it is of ten the case that the stuck residue scales off by the expanding and contracting action of the belt, and thus, does not accumulate above a certain level and a discharge path is not clogged by the residue.

In the above-described thermal activation apparatus, it is preferable that a pulley is provided for both or either of the shafts. With this structure, since the pulley(s) prevent(s) slippage between the shafts and the belt, it is possible to decrease the loss of the amount of advance of the belt due to slippage when the label is discharged.

Further, the present invention can also provide a printer including the above thermal activation apparatus and a print head provided upstream to the thermal activation apparatus in a heat-sensitive adhesive label transport direction for printing on the other side of the heat-sensitive adhesive label.

According to the present invention described above, since adhesive residue on the back side of a heat-sensitive adhesive label hardly accumulates on the discharge mechanism for the label, the discharge path of the heat-sensitive adhesive label is not adversely affected.

### BRIEF DESCRIPTION OF THE DRAWINGS

In the accompanying drawings:

FIG. 1 is a schematic sectional view illustrating a structure of a thermal activation apparatus according to an embodiment of the present invention;

FIG. 2A is a plan view illustrating a structure of a discharge mechanism of FIG. 1;

FIG. 2B is an end view illustrating the structure of the discharge mechanism of FIG. 1;

FIG. 3A illustrates a variation of the discharge mechanism illustrated in FIG. 1, where a pulley is provided to both sides;

FIG. 3B illustrates a variation of the discharge mechanism illustrated in FIG. 1, where a pulley is provided to only one side;

FIG. 4 is a schematic sectional view illustrating an exemplary structure of a conventional thermal activation apparatus;

FIG. 5A is a plan view illustrating a structure of a discharge roller provided for the thermal activation apparatus illustrated in FIG. 4; and

FIG. 5B is an end view illustrating the structure of the discharge roller provided for the thermal activation apparatus illustrated in FIG. 4.

### DETAILED DESCRIPTION OF THE PREFERRED EMBODIMENT

Embodiment of the present invention will be described with reference to the drawings.

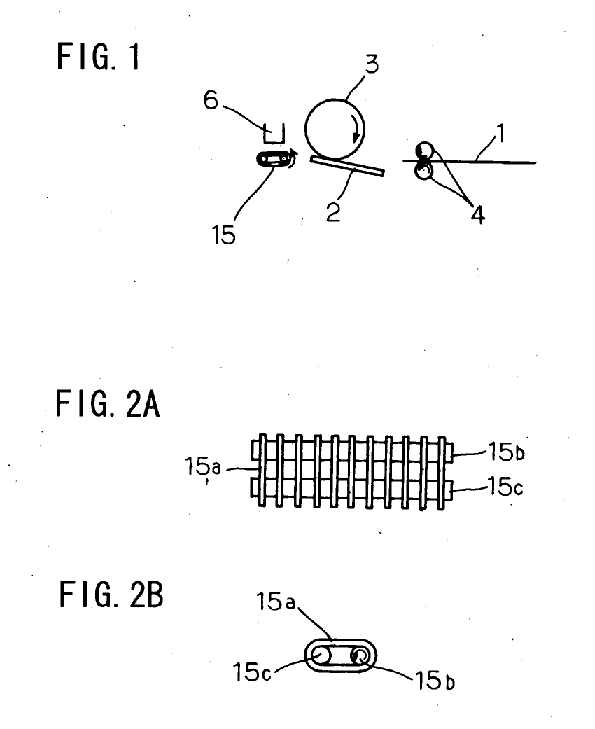

FIG. 1 is a schematic sectional view illustrating a structure of a thermal activation apparatus according to an embodiment of the present invention. In FIG. 1, elements similar to those in FIG. 4 are designated by the same reference numerals.

As illustrated in FIG. 1, a thermal activation apparatus of this embodiment includes a thermal head 2 as a heating head having heating elements for heating a heat-sensitive adhesive agent layer formed on the back side of a heat-sensitive adhesive label 1, a platen roller 3 for transporting the heat-sensitive adhesive label 1 with the heating elements of the thermal head 2 in contact with the heat-sensitive adhesive label 1, insert rollers 4 for inserting the heat-sensitive adhesive label 1 between the thermal head 2 and the platen roller 3, and a discharge mechanism 15 for completely discharging from between the thermal head 2 and the platen roller 3, the heat-sensitive adhesive label 1 with its heat-sensitive adhesive agent layer formed on the back side heated by the thermal head 2.

Further, a catching portion 6 for catching a trailing edge of the heat-sensitive adhesive label 1 which droops under its own weight is provided over the discharge mechanism 15 to prevent the heat-sensitive adhesive label 1 with the adhesion of its heat-sensitive adhesive agent layer formed on the backside generated from dropping from the thermal activation apparatus and sticking to a desk or the like when it is completely discharged from between the thermal head 2 and the platen roller 3.

As the thermal head 2, a thermal head structured similarly to a known print head for a thermal printer is used in which a protective film of crystallized glass is provided on the surface of a plurality of heater resistors formed on a ceramic substrate by thin film technology.

The platen roller 3 is provided with a drive system including, for example, a stepping motor and a gear train. The platen roller 3 is rotated by the drive system to transport the heat-sensitive adhesive label 1 in a predetermined direction (to the left in FIG. 1). Further, the thermal activation apparatus is also provided with pressure means (for example, a coil spring or a leaf spring) for pressing the platen roller 3 against the thermal head 2. Here, by maintaining the rotation axis of the platen roller 3 and the direction of arrangement of the heating elements of the thermal head 2 in parallel with each other, the platen roller 3 can be pressed uniformly over the whole width of the heat-sensitive adhesive label 1.

When the thermal activation apparatus of this embodiment is applied to a printer for a heat-sensitive adhesive label, print means such as a thermal head or an inkjet head which can print on a printable layer formed on the surface of the heat-sensitive adhesive label 1 is provided upstream to the insert rollers 4 in the label transport direction. The heat-sensitive adhesive label 1 may be a sheet or roll paper. When the heat-sensitive adhesive label 1 is roll paper, it is cut to a predetermined length after printing, and then inserted between the thermal head 2 and the platen roller 3 by the insert rollers 4.

The configuration of the thermal activation apparatus, described in the above is different from that of the thermal activation apparatus of FIG. 4 in the discharge mechanism 15 for completely discharging the heat-sensitive adhesive label 1 from between the thermal head 2 and the platen roller 3. The structure of the discharge mechanism 15 will be described hereinafter. FIG. 2A and 2B show a structure of the discharge mechanism, in which FIG. 2A is a plan view, and FIG. 2B is an end view.

The discharge mechanism 15 is structured such that two shafts 15b and 15c made of metal are passed through a plurality of belts 15a which are endless elastic members, the two shafts 15b and 15care disposed at given intervals from each other and in parallel with each other to expand the internal diameters of the respective belts 15a, and the two shafts 15b and 15c are rotatably supported. By driving one of the two shafts 15b and 15c as a driving shaft by rotational drive means which is not shown, the belts 15a rotate to be able to discharge the heat-sensitive adhesive label 1 fed thereonto. It is to be noted that the endless belts 15a may be replaced with O rings.

When the belts 15a are under tension by disposing the two shafts 15b and 15c at the predetermined distance from each other in the loop made by the belts 15a as described in the above, tension difference is caused in the belts 15a between a place where the belts 15a are in contact with the perimeter of the shafts 15b and 15c (hereinafter referred to as a shaft perimeter portion) and a place between the shafts 15b and 15c where the belts 15a are not in contact with the perimeter of the shafts 15b and 15c (hereinafter referred to as an intershaft portion). Even with regard to the intershaft portions, since compressive force acts on the downstream side of the shaft 15b serving as the driving shaft with respect to the direction of the rotation and tensile force acts on the upstream side of the shaft 15b with respect to the direction of the rotation, tension difference is caused in the belts 15a between the downstream side and the upstream side of the driving shaft with respect to the direction of the rotation. Further, with regard to the shaft perimeter portions, tension difference is caused in the belts 15a between the driving shaft side and the driven shaft side. Since these several kinds of tension is continuously caused in the belts 15a during the belts 15a are rotated, the belts 15a are frequently expanded and contracted in places. In other words, this has the effect of expanding the belts 15a in places.

Therefore, even when residue of adhesive on the back side of the heat-sensitive adhesive label 1 sticks to the surfaces of the belts 15a during the heat-sensitive adhesive label 1 is discharged, it is often the case that the stuck residue scales off by the expanding and contracting action of the belts 15a, and thus, does not accumulate above ascertain level and a discharge path is not clogged by the residue.

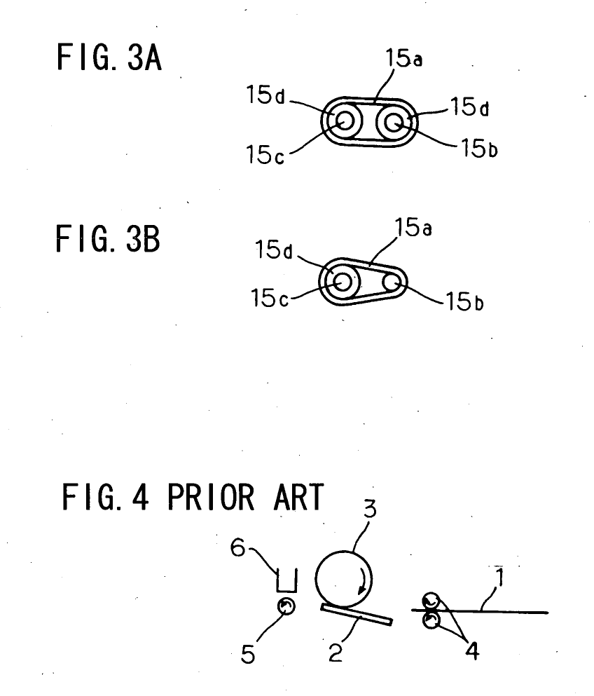

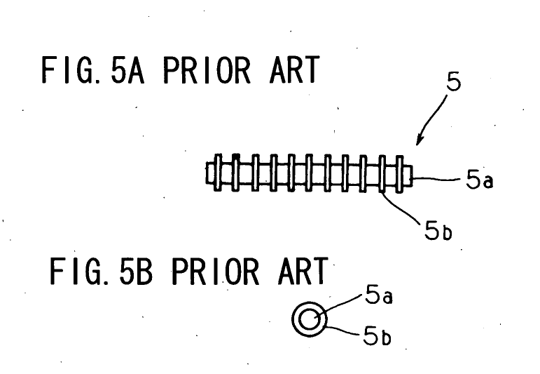

FIG. 3 illustrates variations of the discharge mechanism of FIG. 1.

The one illustrated in FIG. 3A is a variation of the discharge mechanism 15 where a pulley 15d is attached to each of the two shafts 15b and 15c and the endless elastic belts 15a are looped around the pulleys 15d. The discharge mechanism 15 may also be the one illustrated in FIG. 3B where a pulley 15d is attached to only one of the two shafts 15b and 15c and the endless elastic belts 15aare looped around the pulley 15d and the shaft 15b.

In both of the variations illustrated in FIGS. 3A and 3B, the belts 15a are held under tension such that the internal diameters of the belts 15a are increased, which has the effect of expanding the belts 15a in places similarly to the case of the discharge mechanism 15 illustrated in FIG. 2. In particular, the structure illustrated in FIG. 3B causes larger tension difference between the shaft perimeter portion on the driving shaft side and the shaft perimeter portion on the driven shaft side than that caused by the structure illustrated in FIG. 3A, and thus, a higher degree of effectiveness can be expected.

Further, by providing a pulley for both or either of the shafts as in these variations, slippage between the metal shafts 15b and 15c and the belts 15a is prevented. Therefore, the loss of the amount of advance of the belts 15a due to slippage when the label is discharged can be decreased.

What is claimed is:

1. A thermal activation apparatus comprising:
a heating head for heating a heat-sensitive adhesive agent layer formed on one side of a heat-sensitive adhesive label; and
a discharge mechanism for discharging the heat-sensitive adhesive label in contact with the heat-sensitive adhesive agent layer exhibiting adhesion after being heated by the heating head, wherein the discharge mechanism comprises;
an endless elastic belt;
a pair of rotatably supported shafts disposed at given intervals from each other in a loop made by the endless elastic belt such that the internal diameter of the endless elastic belt is increased; and
drive means for rotationally driving one of the shafts.

2. A thermal activation apparatus according to claim 1, further comprising a pulley provided at least one of the shafts.

3. A printer, comprising:
the thermal activation apparatus according to claim 2; and
a print head provided upstream to the thermal activation apparatus in a heat-sensitive adhesive label transport direction for printing on the other side of the heat-sensitive adhesive label.

4. A printer, comprising:
the thermal activation apparatus according to claim 1; and
a print head provided upstream to the thermal activation apparatus in a heat-sensitive adhesive label transport direction for printing on the other side of the heat-sensitive adhesive label.
